(19) United States
(12) Patent Application Publication
(10) Pub. No.: US 2009/0107154 A1
(43) Pub. Date: Apr. 30, 2009

(54) COOLING TRAP UNIT

(75) Inventor: Hisashi Horiuchi, Minamitsuru-gun (JP)

Correspondence Address: FITZPATRICK CELLA HARPER & SCINTO, 30 ROCKEFELLER PLAZA, NEW YORK, NY, 10112, US

(73) Assignee: CANON ANELVA TECHNIX CORPORATION, Kawasaki-shi (JP)

(21) Appl. No.: 12/254,424

(22) Filed: Oct. 20, 2008

(30) Foreign Application Priority Data
Oct. 29, 2007 (JP) 2007-280305

(51) Int. Cl. B01D 8/00

(52) U.S. Cl. 62/55.5

(57) ABSTRACT

A cooling trap unit including a vacuum vessel with a drain port, a refrigerator connected to the vacuum vessel such that an endothermic unit is located on a vacuum side, and a cooling panel which is fixed to the endothermic unit to be in tight contact with it and condenses or solidifies gas, includes a water reservoir unit capable of storing liquefied liquid in the vacuum vessel, when liquefying the gas condensed or solidified by the cooling panel and discharging the liquid outside the vacuum vessel, such that the liquefied liquid is in contact with the cooling panel, and a detection unit for discharging the liquid stored in the water reserving unit through the drain port based on a detection signal which is obtained by detecting a change in temperature of the liquid and indicates that the temperature reaches a predetermined value

### BACKGROUND OF THE INVENTION

1. Field of the Invention

The present invention relates to a cooling trap unit which condenses or solidifies gas molecules of water, oil, or the like drifting in a vacuum at the endothermic unit (cooling unit) of a refrigerator connected to a vacuum vessel, or a cooling portion such as a cooling panel or block attached to the endothermic unit. In particular, the present invention relates to a cooling rap unit comprising a regeneration structure to remove a trapped substance within a shorter time period than in the conventional case.

2. Description of the Related Art

In a cooling trap unit, a refrigerator cools a block- or plate-like cooling panel made of a metal or the like by a refrigerator in a vacuum to condense or solidify gas molecules of water or oil. When the amount of water or oil increases, the cooling panel must be regenerated by raising its temperature. As a regeneration method, the following method is conventionally practiced.

After stopping the refrigerator, the interior of the vacuum vessel is restored to the atmospheric pressure by introducing the atmosphere or N₂ gas into the vacuum vessel to cancel vacuum heat insulation. The condensed or solidified gas is discharged outside the cooling trap unit through a drain port or the like (see Japanese Patent Laid-Open No. 6-182106). To shorten the regeneration time, the vacuum vessel is heated externally by a heater to raise the ambient temperature of the solidified substance, thus shortening the time required for liquefaction.

FIG. 5 is a side sectional view of the main part of a low-temperature trap with a liquid collector disclosed in Japanese Patent Laid-Open No. 6-182106.

A vacuum device 51 is integrally connected to a diffusion pump 53 through a low-temperature trap vacuum vessel 52. A low-temperature trap 55 which is cooled by a compact helium refrigerator 54 to condense the gas molecules of water or oil is arranged in the low-temperature trap vacuum vessel 52. A liquid collector 56 having a liquid reservoir 56a is attached to the low-temperature trap vacuum vessel 52 through a support rod 57 so as to be located immediately under a low-temperature trap surface 55a of the low-temperature trap 55. The liquid collector 56 is always at room temperature.

A drain pipe 58 and drain valve 58a to discharge the collected liquid to the outside are attached to the liquid collector 56. The liquid of water or oil which is generated during regeneration by melting and removing a condensate 55b drips from the low-temperature trap surface 55a restored to the room temperature, and is collected by the liquid collector 56. By restoring the interior of the trap to the atmospheric pressure and opening the drain valve 58a, the liquid collected in the liquid collector 56 can be removed in the form of liquid.

The prior art described above has the following problems. For example, for the purpose of shortening the regeneration time, the vacuum vessel may be externally heated by a heater to raise the ambient temperature of the solidified water, thus promoting liquefaction. The heat capacity of the gas, however, cannot necessarily be larger than the heat capacity of ice or the heat of fusion of water, and the regeneration time cannot be largely shortened. When adopting the prior art, it may adversely affect the operation rate or the like of an apparatus that employs the cooling trap unit, which is inconvenient. When the amount of trapped water changes, the regeneration time also changes. Meanwhile, it is difficult to determine when water discharge is ended and when regeneration is ended. In addition, as the heater heats the peripheral components such as the refrigerator, seal component, electric component, and the like, temperature adjustment need be performed by considering the heat resistant temperatures of the respective components.

### SUMMARY OF THE INVENTION

It is, therefore, an object of the present invention to provide a cooling trap unit comprising a regeneration structure which largely shortens the regeneration time in regeneration of discharging a gas condensed or solidified by a cooling panel outside a vacuum vessel.

According to one aspect of the present invention, there is provided a cooling trap unit including a vacuum vessel with a drain port, a refrigerator connected to the vacuum vessel such that an endothermic unit is located on a vacuum side, and a cooling panel which is fixed to the endothermic unit to be in tight contact therewith and condenses or solidifies gas, comprising:

water reservoir means capable of storing liquefied liquid in the vacuum vessel, when liquefying the gas condensed or solidified by the cooling panel and discharging the liquid outside the vacuum vessel, such that the liquefied liquid is in contact with the cooling panel; and

detection means for discharging the liquid stored in the water reserving means through the drain port based on a detection signal which is obtained by detecting a change in temperature of the liquid and indicates that the temperature reaches a predetermined value.

According to the present invention, in the regeneration process, the liquefied liquid is not discharged directly but stored in the vacuum vessel. Then, the liquid with a large heat capacity comes into direct contact with the cooling panel and solidified gas. This can accelerate liquefaction of the solidified gas, thus shortening the regeneration time.

A temperature sensor provided to the endothermic unit detects a change in temperature of the gas stored in the vacuum vessel. This allows the operator to notice when the gas solidified by the cooling panel has liquefied entirely. Furthermore, based on a detection signal indicating that the temperature has reached a predetermined value, the stored water can be discharged through the drain port of the vacuum vessel, and the operator can be informed of regeneration completion of the cooling trap unit.

Therefore, even if the trapped gas amount differs in each regeneration, regeneration can be performed in accordance with the amount. This is particularly effective when operating the cooling trap unit and performing the regeneration process in accordance with an automatic program, and exhibits its effect when incorporating this trap in an automated apparatus or the like.

Further features of the present invention will become apparent from the following description of exemplary embodiments with reference to the attached drawings.

### BRIEF DESCRIPTION OF THE DRAWINGS

FIG. 1 is a schematic view of an example of a cooling trap unit comprising a regeneration structure according to the first embodiment, in which a vacuum vessel is attached to a refrigerator;

FIG. 2 is a graph showing the equilibrium vapor pressure characteristics of water;

FIG. 3 is a schematic view showing an example of a cooling trap unit comprising a regeneration structure according to the second embodiment, in which a water tank is arranged at the bottom of a vacuum vessel;

FIGS. 4A and 4B are views showing an example in which groove-like steps are formed in the surface of a cooling panel according to the third embodiment; and

FIG. 5 is a side sectional view of the main part of a low-temperature trap with a liquid collector disclosed in Japanese Patent Laid-Open No. 6-182106.

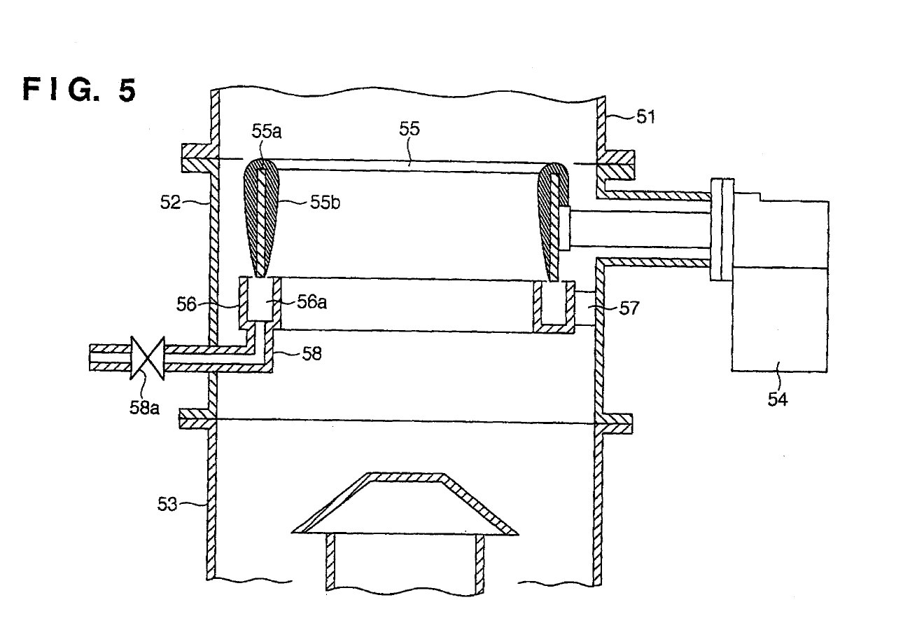

### DESCRIPTION OF THE EMBODIMENTS

The embodiments of the present invention will be described with reference to the accompanying drawings.

As the liquid component contained in the gas, water, oil, or the like can be raised. The following embodiments will be made exemplifying water as the liquid component contained in the gas.

### First Embodiment

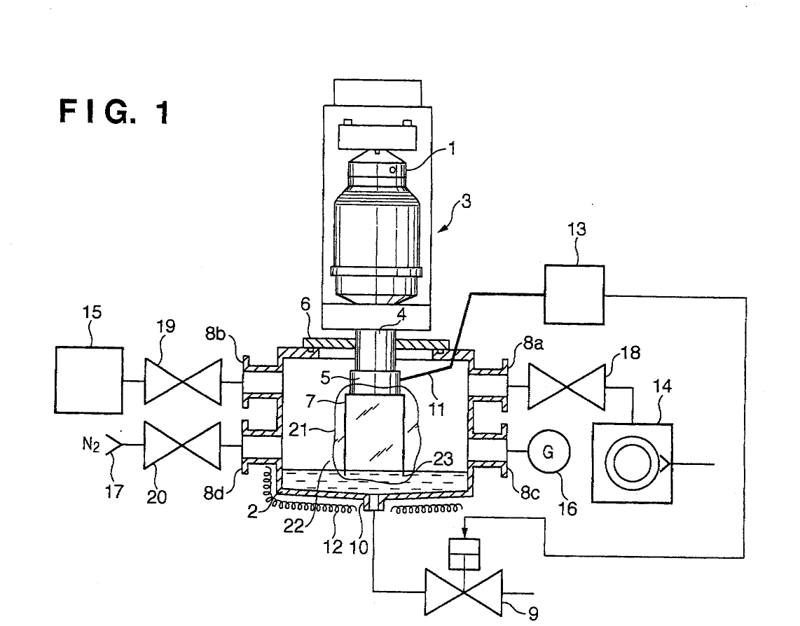

FIG. 1 is a schematic view of an example of a cooling trap unit comprising a regeneration structure according to this embodiment, in which a vacuum vessel is attached to a refrigerator.

Referring to FIG. 1, a description will be made on a cooling tap unit 3 in which a vacuum vessel 2 is attached to a refrigerator 1 such as a vacuum-flanged Stirling cycle refrigerator. The refrigerator 1 employed in the present invention can be any one of various types of refrigerators such as a Stirling, GM, pulse-tube, Solvay cycle, or compressor refrigerator.

The refrigerator 1 has an endothermic unit 5 and vacuum flange 6 attached to the distal end of a cylindrical casing 4. A cylindrical thin plate called a cooling panel 7, which is made of a material with high thermal conductivity (e.g., copper), is attached to the endothermic unit 5 of the refrigerator 1 on the vacuum side to be in tight contact with it. When the refrigerator 1 operates, the temperature of the endothermic unit 5 lowers, and accordingly the temperature of the cooling panel 7 also lowers.

The vacuum vessel 2 comprising a plurality of vacuum-flanged ports 8a, 8b, 8c, and 8d, a drain port 10 connected to a valve 9, a temperature sensor 11, and a heater 12 is fixed to the vacuum flange 6 of the refrigerator 1. At least one drain port 10 is provided to the bottom of the vacuum vessel 2. The temperature sensor 11 is connected to a temperature indicator 13 having an output function of operating the valve 9. This arrangement constitutes the cooling tap unit 3.

When liquefying gas condensed or solidified by the cooling panel 7 and discharging the resultant liquid outside the vacuum vessel 2, the bottom of the vacuum vessel 2 serves as a water reservoir means which can store the liquid obtained by liquefaction to be in contact with the cooling panel 7.

The plurality of vacuum-flanged ports 8a to 8d of the vacuum vessel 2 are connected to a vacuum pump 14 such as a rotary pump or dry pump, a chamber 15 serving as a vacuum space, a vacuum pressure gauge 16, an N₂ gas inlet port 17, and the like. Where necessary, vacuum valves 18, 19, and 20 are provided to the portions between the vacuum pump 14 and vacuum vessel 2, the chamber 15 and vacuum vessel 2, and the N₂ gas inlet port 17 and vacuum vessel 2, respectively.

An example of the operation procedure of the system in FIG. 1 will be described. With the valves 9, 18, 19, and 20 being closed, the vacuum pump 14 is operated. The valve 18 between the vacuum pump 14 and vacuum vessel 2 is opened, and the interior of the vacuum vessel 2 of the cooling tap unit 3 is vacuum-evacuated. The refrigerator 1 is operated to lower the temperature of the cooling panel 7. The valve 19 between the vacuum vessel 2 and chamber 15 is opened, and the interior of the chamber 15 is vacuum-evacuated. At this time, the cooling panel 7 attached to the endothermic unit 5 of the refrigerator 1 solidifies the moisture in the gas flowing from the chamber 15 toward the vacuum pump 14. The larger the amount of moisture present on the side of the chamber 15, the larger the amount of moisture to be occluded by the cooling panel 7 increases. Note that attention must be paid to the temperature of the cooling panel 7.

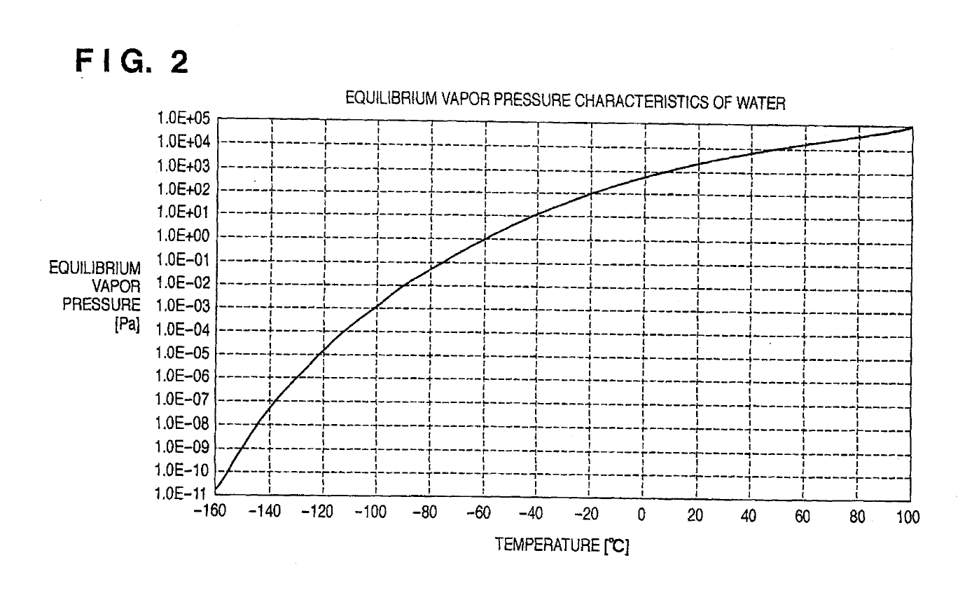

FIG. 2 is a graph showing the equilibrium vapor pressure characteristics of water. From FIG. 2, when the equilibrium vapor pressure is 1 Pa, the temperature of the cooling panel 7 must be maintained at −60° C. or less. In the case of a dry pump, the ultimate pressure as one of the pump performances is on the order of several Pa. If the temperature of the cooling panel 7 is maintained at about −80° C. (the equilibrium vapor pressure of water at this temperature is smaller than 1×10⁻¹ Pa), the moisture in the vacuum is occluded by the cooling panel 7 without any problems.

Assume that this system is used in a process where operations using the atmospheric pressure and vacuum pressure are repeated on the side of the chamber 15 or a process where a moisture constantly enters externally. The moisture is gradually deposited on the cooling panel 7 to cover it with an ice mass 21. Then, problems arise as follows. Namely, as the ice mass 21 fills the interior of the vacuum vessel 2, a flow channel 22 between the chamber 15 and vacuum pump 14 becomes narrow, and the intended evacuation performance is impaired. Also, part of the ice may come into contact with the inner wall surfaces of the vacuum vessel 2 and vacuum flange 6 of the cooling tap unit 3, and the moisture occluded from the contact portion may be evaporated and released into the vacuum again.

In this case, a regeneration process of discharging the deposited ice into the atmosphere must be performed by, for example, stopping the refrigerator 1.

This procedure is performed in the following manner. The valves 18 and 19 are closed to disconnect the cooling tap unit 3 from the vacuum line (the vacuum pump 14 and chamber 15). The operation of the refrigerator 1 is stopped. The valve 20 is opened, and the interior in the vacuum vessel 2 is restored to the atmospheric pressure by N₂ gas purge. The valve 9 of the drain port 10 provided to the bottom of the vacuum vessel 2 is kept closed. At this time, the vacuum vessel 2 may be externally heated by the heater 12. According to this embodiment, the heater 12 serves as a heating means for heating the cooling panel 7 from outside the vacuum vessel 2 when discharging the gas condensed or solidified by the cooling panel 7 to the outside of the vacuum vessel 2.

Assume that part of the ice mass 21 liquefies and collects at the bottom of the vacuum vessel 2, and the liquefied water comes into contact with a lower end 23 of the cooling panel 7 or the ice mass 21. As the heat capacity of water is larger than that of air or the N₂ gas, melting of the ice mass 21 is promoted, and the time (regeneration time) required for the regeneration process decreases. At this time, the temperature sensor 11 provided to the endothermic unit 5 detects the water temperature through the cooling panel 7 and endothermic unit 5. Because the water is in the middle of melting from solid to liquid, the water temperature is maintained at 0° C. When the ice mass 21 completely melts, the water temperature increases due to the influence of the ambient temperature. Assume that the temperature indicator 13 is set to output an operation signal to the valve 9 when, for example, the water temperature reaches, for example, 2° C. Then, when the temperature is 2° C., the valve 9 opens and water stored in the vacuum vessel 2 is discharged. The interior of the vacuum vessel 2 is then dried by purging with the N₂ gas, thus completing the regeneration process. In this manner, in the regeneration process, the melted water is stored in the vacuum vessel 2 to be in contact with the cooling panel 7. The temperature sensor 11 provided to the endothermic unit 5 detects the change in water temperature. The opening/closing operation of the valve 9 is controlled based on the detection signal which is output from the temperature indicator 13 when the temperature reaches the predetermined value. Then, the melted water is discharged through the drain port 10.

As described above, according to this embodiment, in the regeneration process, the liquefied gas is not discharged directly but stored in the vacuum vessel. Then, the liquid with a large heat capacity comes into direct contact with the cooling panel and solidified gas. This can accelerate liquefaction of the solidified gas, thus shortening the regeneration time.

According to this embodiment, the temperature sensor provided to the endothermic unit detects a change in temperature of the gas stored in the vacuum vessel. This allows the operator to notice when the gas solidified by the cooling panel has liquefied entirely. Furthermore, based on the detection signal indicating that the temperature has reached the predetermined value, the stored water can be discharged through the drain port of the vacuum vessel, and the operator can be informed of regeneration completion of the cooling trap unit.

Therefore, even if the trapped gas amount differs in each regeneration, the regeneration process can be performed in accordance with the amount. This is particularly effective when operating the cooling trap unit and performing the regeneration process in accordance with an automatic program, and exhibits its effect when incorporating this trap in an automated apparatus or the like.

### Second Embodiment

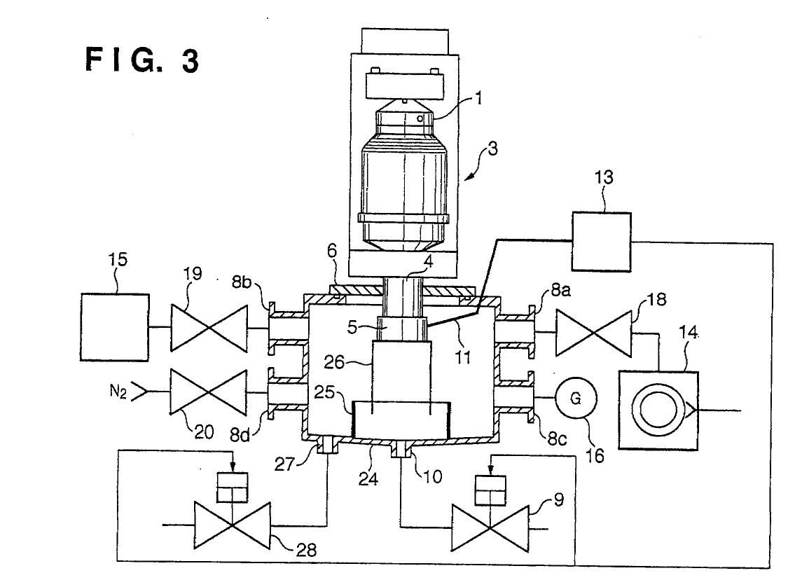

FIG. 3 is a schematic view showing an example of a cooling trap unit comprising a regeneration structure according to the second embodiment, in which a water tank is arranged at the bottom of a vacuum vessel. Portions that are common with those in the first embodiment are denoted by the same reference numerals.

In the arrangement shown in FIG. 3, a water tank 25 is arranged in a vacuum vessel 24 to be located under a cooling panel 26, and has a bottom area smaller than that of the vacuum vessel 24. In this arrangement, water melted in the regeneration process is stored in the water tank 25 and localizes immediately under the cooling panel 26.

The water stored in the water tank 25 can be discharged through a drain port 10. According to this embodiment, the drain port 10 serves as the first drain port to discharge the water stored in the water tank 25. Thus, even at a stage where the amount of liquefied water is small, the cooling panel 26 can be in contact with the water stored in the water tank 25. This promotes liquefaction and can create an easy-to-liquefy situation at an early timing. In this case, even if the melted water overflows from the water tank 25, it only gathers around the water tank 25 and can be discharged through a drain port 27, thus posing no problems. More specifically, a valve 28 connected to the drain port 27 provided to the periphery of the water tank 25 also opens based on a detection signal output from a temperature indicator 13 at the same timing when an ice mass 21 has entirely liquefied, when the liquid temperature rises, and when a valve 9 opens, to discharge the water overflowing from the water tank 25. The water overflowing from the water tank 25 and stored outside the water tank 25 (the water directly stored at the bottom of the vacuum vessel 24) can also be discharged through the drain port 27. In this embodiment, the drain port 27 serves as the second drain port to discharge the water stored outside the water tank 25.

According to this embodiment, the water tank that stores water melted in the regeneration is arranged below the cooling panel. This can cause the water to quickly come into contact with the cooling panel or the solidified water. As a result, the regeneration time can be further shortened.

### Third Embodiment

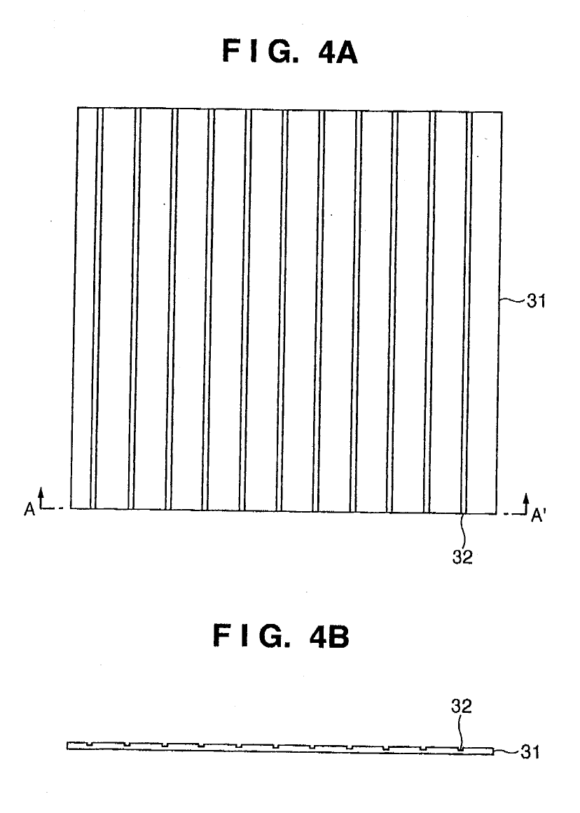

FIGS. 4A and 4B are views showing an example in which groove-like steps 32 are formed in the surface of a cooling panel according to the third embodiment, in which FIG. 4A is a plan view of the surface of the cooling panel, and FIG. 4B is a side view of a cooling panel 31 seen from a direction AA′. Note that the cooling panels 7 and 26 of the first and second embodiments are cylindrical, whereas the cooling panel 31 of the third embodiment is a flat one which is obtained before machining into a cylindrical shape.

As shown in FIGS. 4A and 4B, the surface of the cooling panel 31 is provided with the plurality of longitudinal groove-like steps 32 extending vertically downward from above in the direction of gravity. The groove-like steps are not limited to longitudinal ones extending vertically downward, as shown in FIG. 4A, but can be inclined (not shown) downward from above. By forming the grove-like steps in the surface of the cooling panel 31, the water liquefied on the cooling panel 31 can flow downward easily along the groove-like steps 32. Thus, the water drips from the cooling panel smoothly so that the liquefied water can be discharged efficiently. This is effective in shortening the regeneration time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-280305, filed Oct. 29, 2007, which is hereby incorporated by reference herein in its entirety.

What is claimed is:

1. A cooling trap unit including a vacuum vessel with a drain port, a refrigerator connected to said vacuum vessel such that an endothermic unit is located on a vacuum side, and a cooling panel which is fixed to said endothermic unit to be in tight contact therewith and condenses or solidifies gas, comprising;
water reservoir means capable of storing liquefied liquid in said vacuum vessel, when liquefying the gas condensed or solidified by said cooling panel and discharging the liquid outside said vacuum vessel, such that the liquefied liquid is in contact with said cooling panel; and
detection means for discharging the liquid stored in said water reserving means through said drain port based on a detection signal which is obtained by detecting a change in temperature of the liquid and indicates that the temperature reaches a predetermined value.

2. The unit according to claim 1, wherein said water reserving means includes a water tank which is arranged below said cooling panel in said vacuum vessel and includes an area smaller than that of a bottom of said vacuum vessel.

3. The unit according to claim 2, wherein said vacuum vessel includes
a first drain port to discharge the liquid stored in said water tank, and
a second drain port to discharge the liquid stored outside said water tank.

4. The unit according to claim 1, further comprising heating means for heating said cooling panel from outside said vacuum vessel when discharging the gas condensed or solidified by said cooling panel to outside said vacuum vessel.

5. The unit according to claim 1, wherein said cooling panel is provided with a plurality of groove-like steps in a surface thereof, which are formed in one of a longitudinal direction and an oblique direction and extend downward from above in a direction of gravity.
